(19) United States
(12) Patent Application Publication
(10) Pub. No.: US 2026/0091800 A1
(43) Pub. Date: Apr. 2, 2026

(54) IN-VEHICLE APPARATUS

(71) Applicant: DENSO TEN Limited, Kobe (JP)

(72) Inventors: Yuki MATSUMOTO, Kobe (JP); Shota KINOSHITA, Kobe (JP); Takashi KONO, Kobe (JP); Naoshi KAKITA, Kobe (JP); Hiroki IMORI, Kobe (JP); Atsushi MINO, Kobe (JP)

(73) Assignee: DENSO TEN Limited, Kobe (JP)

(21) Appl. No.: 19/317,382

(22) Filed: Sep. 3, 2025

(30) Foreign Application Priority Data
Sep. 27, 2024 (JP) 2024-168658

(51) Int. Cl. B60W 50/14; B60W 30/18; B60W 50/00; G06V 10/56; G06V 20/58

(52) U.S. Cl. CPC B60W 50/14; B60W 30/18018; G06V 10/56; G06V 20/584; B60W 2050/0083; B60W 2050/143; B60W 2050/146; B60W 2420/403; B60W 2520/10; B60W 2555/60; B60W 2556/50

(57) ABSTRACT

An in-vehicle apparatus includes a controller. The controller is configured to provide a first notification to prompt a driver to start a vehicle in response to determining that the vehicle continues to stop until a first predetermined time elapses after detecting, by image recognition of an image captured by a camera, that a traffic light has changed from red to green, and is configured not to provide a second notification to prompt the driver to start the vehicle in response to detecting that the traffic light has changed from red to green again while the vehicle continues to stop after providing the first notification.

### BACKGROUND OF THE INVENTION

### Field of the Invention

The invention relates to an in-vehicle apparatus and a non-transitory computer-readable recording medium.

### Description of the Background Art

Conventionally, an in-vehicle apparatus that records a video obtained by capturing an image around a vehicle, that is, a drive recorder has been known. There has been a technology that detects that a traffic light has changed from red to green by analyzing the captured video, and that provides a notification to start an own vehicle in a state where the own vehicle is stopped even though the traffic light is green (for example, refer to the Japanese Published Unexamined Patent Application No. 2016-134034).

However, in the conventional technology, since the notification is repeated until the vehicle starts, in a case where the vehicle is parked on the street near the traffic light, the notification is provided every time the traffic light changes to green. That is, in the conventional technology, although a driver does not intend to start the own vehicle due to parking on street, and the like, if the notification is repeated, the driver may feel annoyed with the notification.

### SUMMARY OF THE INVENTION

According to one aspect of the invention, an in-vehicle apparatus including a controller, the controller configured to provide a first notification to prompt a driver to start a vehicle in response to determining that the vehicle continues to stop until a first predetermined time elapses after detecting, by image recognition of an image captured by a camera, that a traffic light has changed from red to green, and perform a process of not providing a second notification to prompt the driver to start the vehicle in response to detecting that the traffic light has changed from red to green again while the vehicle continues to stop after providing the first notification.

It is an object of the invention to provide an in-vehicle apparatus and a non-transitory computer-readable recording medium capable of reducing annoyance of a driver due to a notification.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 illustrates an outline of a process executed by a drive recorder according to an embodiment;

FIG. 2 illustrates a configuration example of the drive recorder according to the embodiment;

FIG. 3 illustrates an operation example in a scene (No. 1);

FIG. 4 illustrates an operation example in a scene (No. 2);

FIG. 5 illustrates an operation example in a scene (No. 3);

FIG. 6 illustrates an operation example in a scene (No. 4); and

FIG. 7 is a flowchart illustrating a processing procedure of a notification process of the drive recorder according to the embodiment.

### DESCRIPTION OF THE EMBODIMENTS

Hereinafter, an in-vehicle apparatus and a non-transitory computer-readable recording medium according to an embodiment will be described in detail with reference to the accompanying drawings. This invention is not limited to the embodiment described below.

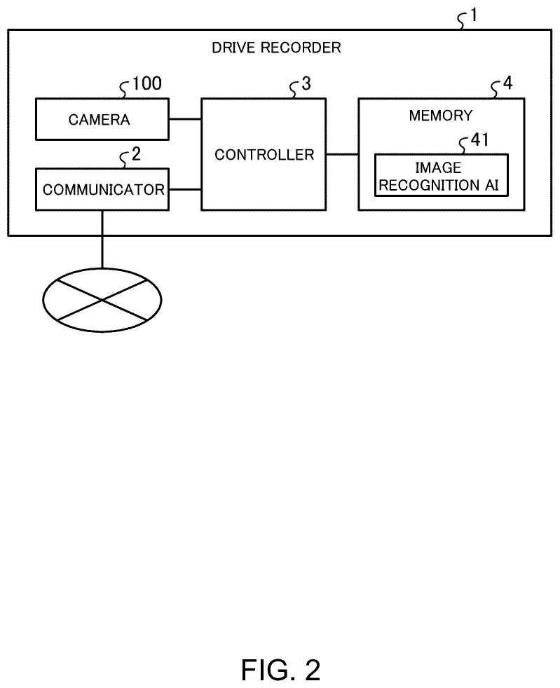

Hereinafter, the in-vehicle apparatus according to the embodiment is a drive recorder 1 to be mounted in a vehicle. Furthermore, a control program of the in-vehicle apparatus according to the embodiment is a control program executed by a controller 3 (refer to FIG. 2) included in the drive recorder 1.

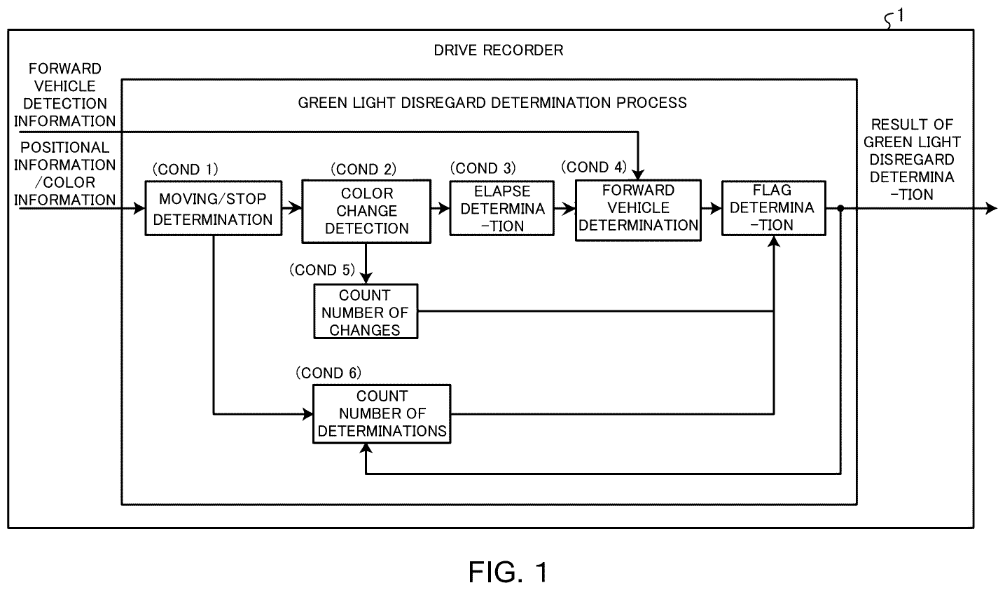

First, an outline of a process executed by the drive recorder 1 according to the embodiment will be described with reference to FIG. 1. FIG. 1 illustrates the outline of the process executed by the drive recorder 1 according to the embodiment. In FIG. 1, among the processes executed by the drive recorder 1, a green light disregard determination process will be described. Green light disregard means a situation in which an own vehicle has not started even though a traffic light has changed from red to green.

When the traffic light has changed from red to green, the drive recorder 1 according to this embodiment does not provide a notification to prompt a driver to start a vehicle after providing the notification. Specifically, after providing the notification to prompt the driver to start the vehicle, when the traffic light has changed from red to green again in a state where the vehicle continues to stop, the drive recorder 1 stops the notification to prompt the driver to start the vehicle (does not provide a re-notification). Alternatively, after providing a first notification to prompt the driver to start the vehicle, the drive recorder 1 stops the re-notification until the vehicle starts.

Thus, when the driver intentionally stops the vehicle even after the first notification, the re-notification is not provided. That is, since the drive recorder 1 does not repeat the notification when the driver does not intend to start the vehicle due to parking on street, and the like, the drive recorder 1 reduces annoyance of the driver due to the notification.

The above will be described in detail with reference to FIG. 1.

Specifically, the drive recorder 1, first, obtains forward vehicle detection information, positional information, and color information. The forward vehicle detection information means information about other vehicles (forward vehicle) that exist in front of the own vehicle and includes information about a presence or absence of other vehicles and information about distance to the forward vehicle. The forward vehicle detection information may be, for example, information obtained by analyzing an image captured by the drive recorder 1 or information detected by a vehicle detection sensor (distance measuring sensor, etc.). The positional information indicates a position of the traffic light that exists around the own vehicle. The color information is obtained by analyzing the image captured by the drive recorder 1. For example, the drive recorder 1 performs a template matching on the captured image and identifies a traffic light region in which the traffic light exists from the image. The color information indicates a lighting state of the traffic light (having a red light, a green light, and a yellow light) indicated by the positional information. The drive recorder 1 identifies a current lighting color (red, green, or yellow) as the color information by analyzing the image of the traffic light region.

Subsequently, the drive recorder 1 performs the green light disregard determination process using the obtained forward vehicle detection information, positional information, and color information. Specifically, when Conditions 1 to 6 illustrated in FIG. 1 are met, the drive recorder 1 determines that the green light disregard has occurred in a flag determination process (sets a green light disregard flag).

In this embodiment, Conditions 1 to 4 are for determining the green light disregard, and Conditions 5 and 6 are for preventing the re-notification. In this embodiment, particularly, since Conditions 5 and 6 are provided, the re-notification is prevented, so that the annoyance of the driver due to the notification is reduced. Hereinafter, a summary of each condition will be described, and details of each condition will be described later.

### (Condition 1)

A process of Condition 1 is for determining whether the own vehicle is moving or stopped (i.e., during a stop of the own vehicle). In the process of Condition 1, the drive recorder 1 determines whether the own vehicle is moving or stopped. When the drive recorder 1 determines that the own vehicle is moving, the drive recorder 1 sets a “moving flag”. When the drive recorder 1 determines that the own vehicle is stopped, the drive recorder 1 sets a “stop flag”.

### (Condition 2)

A process of Condition 2 is for determining whether or not the lighting state of the traffic light has changed. In the process of Condition 2, the drive recorder 1 determines a presence or absence of change in the lighting state of the traffic light and the color information after the change. While the “stop flag” is set and when the traffic light has changed from red to green, the drive recorder 1 sets a “color change flag”.

### (Condition 3)

A process of Condition 3 is for calculating an elapsed time from a time at which the lighting state of the traffic light has changed in the process of Condition 2 and determining that the elapsed time has reached a threshold time. In the process of Condition 3, the drive recorder 1 determines whether or not the elapsed time from the time at which the lighting state of the traffic light has changed is equal to the threshold time or longer. The drive recorder 1 sets an “elapsed flag” at a time at which the threshold has elapsed after setting the “color change flag”. In a state where the “elapsed flag” is set, when the “moving flag” has been set, the drive recorder 1 puts down the “elapsed flag” that has been set.

### (Condition 4)

A process of Condition 4 is for determining whether or not the forward vehicle exists within a threshold distance. The drive recorder 1 determines whether or not the forward vehicle exists within the threshold distance in the process of Condition 4. When the forward vehicle exists within the threshold distance, the drive recorder 1 sets a “forward vehicle-presence flag”.

### (Condition 5)

A process of Condition 5 is for counting a number of color changes of the traffic light in the process of Condition 2. The drive recorder 1 counts a number of changes from red to green (a number of green changes) and a number of changes from green to red (a number of red changes) in the traffic light. The number of red changes means the number of changes from green to red without passing yellow. In other words, the number of red changes means, when red is falsely detected as green (green is falsely detected as red), the number of changes that the lighting state changes from green (actually, red) to red (actually, green). While the “stop flag” is set, the drive recorder 1 counts the number of green changes and the number of red changes. Then, when the “moving flag” is set, the drive recorder 1 resets each of count values.

### (Condition 6)

A process of Condition 6 is for counting a number of times of determining (a number of determinations) that the own vehicle has disregarded the green light during the stop of the own vehicle. The drive recorder 1, in the process of Condition 6, counts the number of determinations that the green light has been disregarded (a number of outputs of the green light disregard flag) in the flag determination process. When the “stop flag” changes to the “moving flag”, and then, the “stop flag” is set again, the drive recorder 1 resets the count values.

### (Flag Determination)

In the flag determination process, it is determined whether the own vehicle has disregarded the green light based on results of the processes of Conditions 1 to 6. Specifically, when the “stop flag”, the “color change flag”, and the “elapsed flag” are set, and the “forward vehicle-presence flag” is not set, the drive recorder 1 determines that Conditions 1 to 4 are met. When the number of green changes is one, and the number of red changes is zero under Condition 5, the drive recorder 1 determines that Condition 5 is met. When the number of determinations is zero under Condition 6, the drive recorder 1 determines that Condition 6 is met. When Conditions 1 to 6 are all met, the drive recorder 1 determines that the own vehicle has disregarded the green light, and outputs the “green light disregard flag” indicating that the green light disregard has occurred.

When the green light disregard flag is output, the drive recorder 1 provides the notification to prompt the driver to start the vehicle. On the other hand, at least one of Conditions 1 to 6 is not met, the drive recorder does not output the green light disregard flag. That is, the drive recorder 1 does not provide the notification to prompt the driver to start the vehicle.

For example, even when Conditions 1 to 4 for determining the green light disregard are met, in the process of Condition 5, when the number of green changes is two or more, Condition 5 is not met. Thus, the drive recorder 1 stops the notification for the driver. In this embodiment, in a state where the own vehicle is parked on the street near the traffic light, when the number of times that the traffic light changes from red to green is one, the notification is provided. However, when the number of times that the traffic light changes from red to green is two or more, no notification is provided.

In this way, according to this embodiment, when the traffic light has changed from red to green in the state where the vehicle continues to stop even after the first notification, the re-notification is stopped. Thus, the notification is prevented from being repeated although the driver does not intend to start the own vehicle. That is, according to this embodiment, it is possible to reduce the annoyance of the driver due to the notification.

After the first notification, when the own vehicle starts to move, the drive recorder 1 resets each of the count values of Condition 5 and Condition 6, and at the next stop of the own vehicle, determines whether or not to provide the first notification (whether or not Conditions 1 to 6 are met). That is, after the first notification, the drive recorder 1 stops the re-notification until the own vehicle starts.

As described above, according to this embodiment, after the first notification, the re-notification is stopped until the own vehicle starts. Thus, since while the own vehicle is stopped, the re-notification is stopped, the notification is prevented from being repeated even though the driver does not intend to start the own vehicle. That is, according to this embodiment, it is possible to reduce the annoyance of the driver due to the notification.

An example has been described in which, after providing the first notification, the drive recorder 1 again determines whether or not Conditions 1 to 6 are met to determine whether or not to provide the re-notification. On the other hand, after the first notification, since Condition 6 is not met until the own vehicle starts, the drive recorder 1 may stop the determination process itself for Conditions 1 to 6.

When the drive recorder 1 has detected the green light disregard, the drive recorder 1 may store an image at a detection time by associating the image with detection of the green light disregard. When the drive recorder 1 has detected the green light disregard, the drive recorder 1 may associate the detection of the green light disregard with information of whether or not the above-mentioned notification (the first notification or the re-notification) has been provided. When the drive recorder 1 has detected the green light disregard, the drive recorder 1 may transmit the image at the detection time associated with the detection of the green light disregard to an external device.

Next, a configuration example of the drive recorder 1 will be described with reference to FIG. 2. FIG. 2 illustrates the configuration example of the drive recorder 1 according to the embodiment. As illustrated in FIG. 2, the drive recorder 1 has a camera 100, a communicator 2, a controller 3, and a memory 4.

The camera 100 is provided to capture at least an image in front of the vehicle. The camera 100 is mounted near a front windshield, a dashboard, and the like.

The drive recorder 1 is connected to various sensors (not shown) mounted in the vehicle. Examples of the sensors include a vehicle speed sensor that detects a vehicle speed, a GPS (Global Positioning System) sensor that detects positional information of the own vehicle, and the like.

The communicator 2 is realized by a network adaptor, or the like. The communicator 2 is wirelessly connected to a network, such as a portable phone network, or a C-V2X (Cellular Vehicle to Everything) network, and performs data communication with other devices via the network. The communicator 2, for example, performs data communication with a center device of a data center that collects captured images.

The memory 4 is realized by a memory device, such as a ROM (Read Only Memory), a RAM (Random Access Memory), or a flash memory. The memory 4 stores an image recognition AI 41 in an example of FIG. 2.

The image recognition AI 41 is an AI (Artificial Intelligence) model for image recognition. The image recognition AI 41 is, for example, a DNN (Deep Neural Network) model learned using a deep learning algorithm.

After the image recognition AI 41 is read by the controller 3 as the DNN model, when the image captured by the camera 100 is input to the controller 3, the image recognition AI 41 detects the traffic light appearing in the input image. The image recognition AI 41 further detects the lighting state of the traffic light including traffic light colors. That is, the controller 3 that has read the image recognition AI 41 operates as an image recognition AI that detects at least the traffic light and the lighting state of the traffic light.

Although illustration is omitted, the memory 4 stores image data of the image captured by the camera 100, camera parameters, and the like.

The controller 3 corresponds to a processor. The controller 3 is realized by a CPU (Central Processing Unit), an MPU (Micro Processing Unit), a GPU (Graphical Processing Unit), or the like. The controller 3 executes a control program according to the embodiment stored in the memory 4 using the RAM as a work area. The controller 3 is realized by an integrated circuit, such as an ASIC (Application Specific Integrated Circuit) or FPGA (Field Programmable Gate Array).

The controller 3 obtains the forward vehicle detection information, the positional information, and the color information, and performs the green light disregard determination process based on the obtained information. Specifically, the controller 3 determines whether or not Conditions 1 to 6 described above are met based on the obtained information, and when all conditions are met, the controller 3 determines that the green light disregard has occurred.

When the controller 3 determines that the green light disregard has occurred, the controller 3 provides the notification to prompt the driver to start the vehicle. The notification is provided by using arbitrary notification methods, such as screen display, emitting light, voice notification, and warning sound.

When the controller 3 stops the re-notification because one of Conditions 1 to 6 is not met, the controller 3 may stop some of the notification methods described above. For example, when the controller 3 has provided the first notification by the screen display and voice notification (for example, by display and voice, such as “Please check ahead”), the controller 3 may stop the notification by voice and provides the notification only by screen display in the re-notification. That is, when one of Conditions 1 to 6 is not met, the controller 3 may limit the notification methods by stopping some of the notification methods rather than stopping all of the notification methods. That is, the controller 3 provides the first notification by display and voice, and when the own vehicle has not started and continues to stop even after the first notification, the controller 3 provides either the notification by display or the notification by voice in the re-notification. As a result, it is possible to reduce the annoyance of the driver due to the re-notification.

In a state where the re-notification is stopped (re-notification continues to be stopped) because one of Conditions 1 to 6 is not met, when the controller 3 detects that the own vehicle has started, the controller 3 resets the state where the re-notification is stopped. That is, the controller 3 resets the results of the processes of Conditions 1 to 6, and when the own vehicle stops again, the controller 3 performs the determination process for Conditions 1 to 6 to determine whether or not to provide the notification. Thus, the controller 3 prevents the state where no notification is provided even after the own vehicle has started.

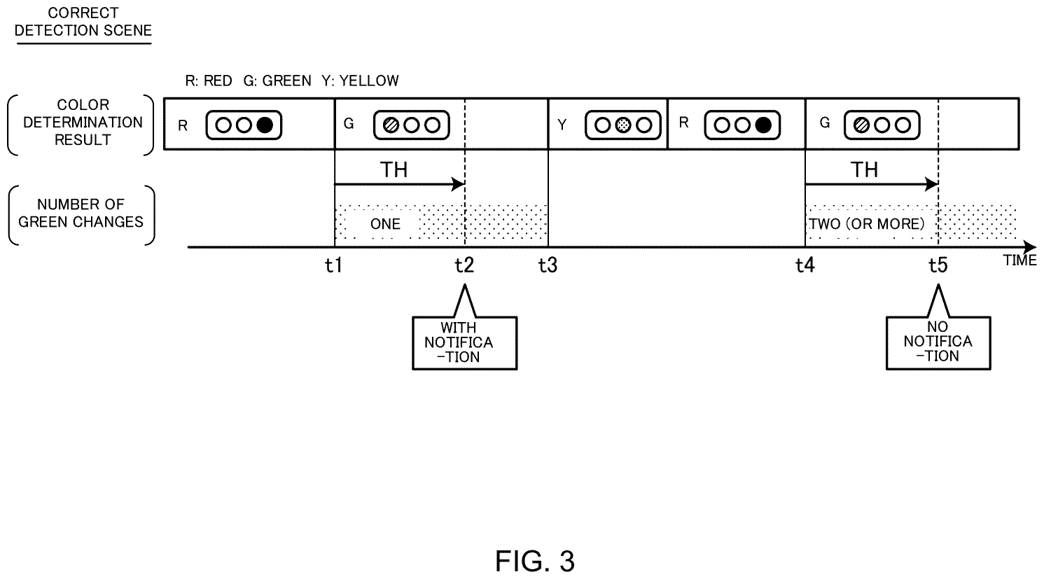

Next, the green light disregard determination process in an actual scene will be described with reference to FIG. 3 to FIG. 6. Each of FIG. 3 to FIG. 6 illustrates an operation example in scenes (No. 1 to No. 4).

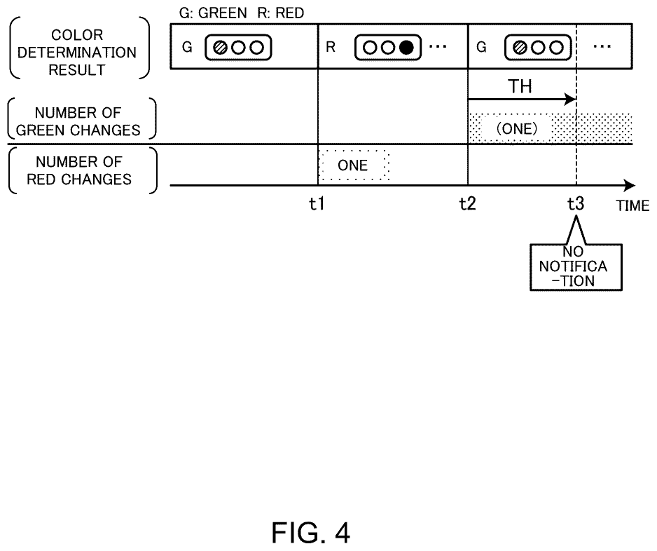

The scenes in FIG. 3 and FIG. 4 (No. 1 and No. 2) will be described. FIG. 3 illustrates the scene in which correct detection (green is correctly detected as green) of the lighting state of the traffic light is performed. FIG. 4 illustrates the scene in which false detection (green is falsely detected as red) of the lighting state of the traffic light is performed. In FIG. 3 and FIG. 4, it is assumed that the own vehicle is stopped at a head of a line (position at which no forward vehicle exists) before the traffic light. That is, in FIG. 3 and FIG. 4, it is assumed to be in a state where the “stop flag” of Condition 1 is set and the “forward vehicle-presence flag” of Condition 4 is not set (state where Conditions 1 and 4 are met).

As illustrated in FIG. 3, in the correct detection scene, it is assumed that the controller 3 detects that the traffic light has changed from red to green. In this case, at a time t1, the controller 3 sets the “color change flag” of Condition 2. Subsequently, at a time t2 after a lapse of a threshold time TH from the time t1, the controller 3 sets the “elapsed flag” of Condition 3 because the threshold time TH has elapsed since the “color change flag” had been set. That is, at the time t2, the controller 3 determines that Conditions 1 to 4 are met. As illustrated in FIG. 3, since the number of green changes is one, and the number of red changes is zero under Condition 5, the controller 3 determines that Condition 5 is met at the time 2. At the time 2, the controller 3 has never provided the notification once since the own vehicle had been stopped. That is, since a green light disregard determination flag has never been output, the controller 3 determines that Condition 6 is met. As a result, at the time 2, since Conditions 1 to 6 are met, the controller 3 provides the first notification to prompt the driver to start the own vehicle.

Subsequently, it is assumed that the traffic light changes to red via yellow between a time 3 and a time 4 and changes from red to green at the time 4. In this case, at the time 4, the controller 3 sets the “color change flag” of Condition 2. Subsequently, at a time t5 after a lapse of the threshold time TH from the time t4, the controller 3 sets the “elapsed flag” of Condition 3 because the threshold time TH has elapsed since the “color change flag” had been set. That is, at the time t5, the controller 3 determines that Conditions 1 to 4 are met. As illustrated in FIG. 3, since the number of green changes is two and the number of red changes is zero under Condition 5, the controller 3 determines that Condition 5 is not met at the time t5. At the time t5, the controller 3 has provided the notification once since the own vehicle had stopped. That is, since the green light disregard determination flag has been output, the controller 3 determines that Condition 6 is not met. As a result, at the time 5, although Conditions 1 to 4 are met, since Conditions 5 and 6 are not met, the controller 3 does not provide the notification. That is, the controller 3 does not provide the re-notification as a notification after the first notification.

As described above, in the scene in which the correct detection of the lighting state of the traffic light is performed, when the number of times that the traffic light changes from red to green is two or more, the re-notification is not provided. Thus, it is possible to reduce the annoyance of the driver due to the notification.

Next, the false detection scene of the lighting state of the traffic light will be described with reference to FIG. 4. It is assumed that the controller 3 detects that the traffic light has changed from green to red at the time t1. In this case, at the time t1, the controller 3 does not set the “color change flag” of Condition 2 because the traffic light changes from green to red. The controller 3 counts the number of red changes of Condition 5 as one. Subsequently, it is assumed that the controller 3 detects that the traffic light has changed from red to green at the time t2. In this case, the controller 3 sets the “color change flag” of Condition 2 at the time t2. Subsequently, at the time t3 after a lapse of the threshold time TH from the time t2, the controller 3 sets the “elapsed flag” of Condition 3 because the threshold time TH has elapsed since the “color change flag” had been set. That is, at the time t3, the controller 3 determines that Conditions 1 to 4 are met. As illustrated in FIG. 4, since the number of green changes is one and the number of red changes is one under Condition 5, the controller 3 determines that Condition 5 is not met at the time t3. As a result, at the time t3, although Conditions 1 to 4 are met, since Condition 5 is not met, the controller 3 does not provide the notification. That is, when the number of red changes is one, the controller 3 determines that the lighting state of the traffic light is falsely detected and does not provide the first notification itself. Even when the number of times that the traffic light changes from red to green is two or more, since the number of red changes is one or more, the controller 3 does not provide the notification.

In this way, since the controller 3 does not provide the first notification in the scene in which the false detection of the lighting state of the traffic light is performed, a false notification due to the false detection is prevented.

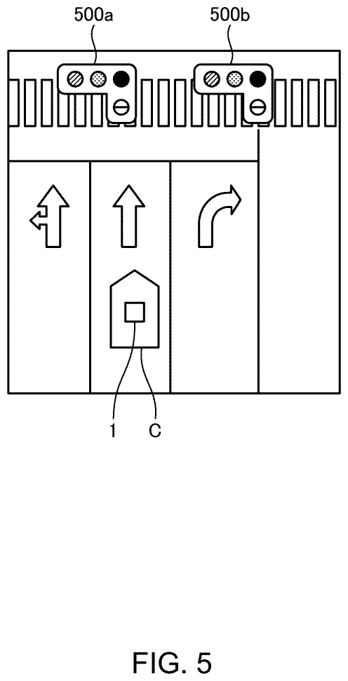

Next, the scene (No. 3) in FIG. 5 will be described. FIG. 5 illustrates the scene in which the controller 3 has detected a plurality of traffic lights 500a, 500b. In FIG. 5, it is assumed that an own vehicle C is stopped at the head of the line (position at which no forward vehicle exists) before the traffic light. That is, in FIG. 5, it is assumed to be in a state where the “stop flag” of Condition 1 is set and the “forward vehicle-presence flag” of Condition 4 is not set (state where Conditions 1 and 4 are met).

As illustrated in FIG. 5, when the plurality of the traffic lights 500a, 500b has been detected, the controller 3 determines whether Conditions 2, 3, and 5 are met for each of the plurality of the traffic lights 500a, 500b. In this case, the controller 3 determines whether or not the plurality of the traffic lights 500a, 500b in turn meets Conditions 2, 3, and 5.

Here, it is assumed that the plurality of the traffic lights 500a, 500b both meet Conditions 2, 3, and 5. That is, it is assumed that the controller 3 determines that each of the plurality of the traffic lights 500a, 500b meets Conditions 1 to 5.

In this case, for example, when the determination process for Conditions 1 to 5 is performed on the traffic light 500a, the controller 3 determines that the traffic light 500a meets Condition 6 because the green light disregard determination flag has zero output. That is, since Conditions 1 to 6 are met, the controller 3 outputs the green light disregard determination flag and provides the first notification.

Subsequently, after the determination process on the traffic light 500a, when the determination process for Condition 1 to 5 is performed on the traffic light 500b, the controller 3 determines that the traffic light 500b does not meet the condition 6 because the green light disregard determination flag has one output. That is, although Conditions 1 to 5 are met, since Condition 6 is not met, the controller 3 does not output the green light disregard determination flag and stops the notification. That is, as in the scene in FIG. 5, when a plurality of the traffic lights has been detected, the controller 3 provides the notification only about the traffic light 500a on which the determination process has been first performed, and stops the notification about the traffic light 500b on which the determination process has been then performed. That is, when the controller 3 has detected the plurality of the traffic lights 500a, 500b by image recognition, the controller 3 counts the number of green changes for each of the plurality of the traffic lights 500a, 500b, and when the accumulated number of changes is a threshold value (two in FIG. 5) or more, the controller 3 stops the re-notification.

As a result, for example, even when the plurality of the traffic lights 500a, 500b changes from red to green simultaneously, by providing the notification only about the traffic light 500a on which the determination process has been first performed, the notification is prevented from being provided about each of the plurality of the traffic light 500a, 500b.

When the vehicle C has started and then stopped, the controller 3 resets the accumulated number. As a result, when the vehicle C has started and then stopped at a next different traffic light, the controller 3 provides a first notification again.

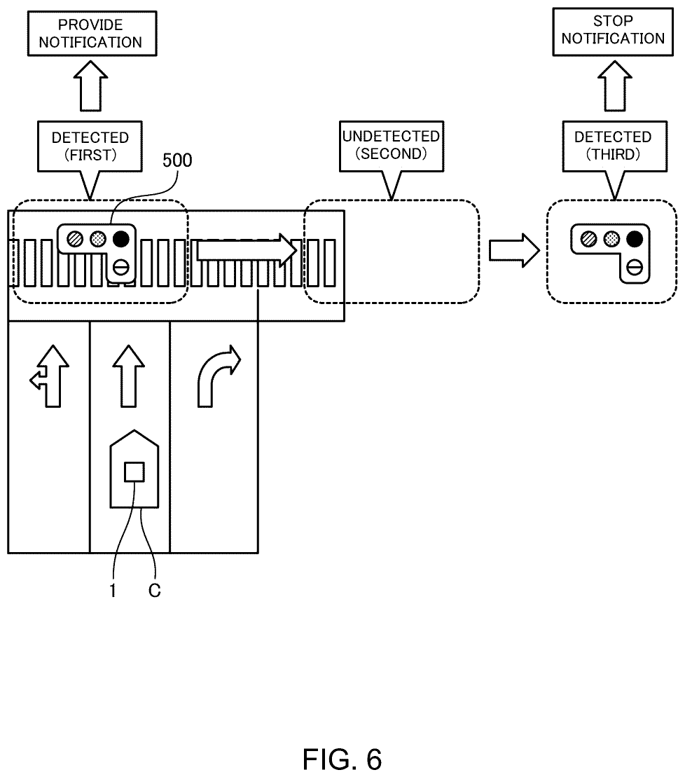

Next, a scene in FIG. 6 (No. 4) will be described. FIG. 6 illustrates the scene in which the same traffic light 500 is detected at the first time (first image frame), and then not detected at the second time, and detected again at the third time. In FIG. 6, it is assumed that the own vehicle C is stopped at the head of the line (position at which no forward vehicle exists) before the traffic light. That is, in FIG. 6, it is assumed to be in the state where the “stop flag” of Condition 1 is set and the “forward vehicle-presence flag” of Condition 4 is not set (state where Conditions 1 and 4 are met).

Even in the case shown in FIG. 6, at the third detection, by trying not to meet Condition 6, when the traffic light 500 is detected again, the notification is not erroneously treated as the first notification.

Specifically, it is assumed that, since Conditions 1 to 5 are first met at the first detection, and the number of outputs of the green light disregard flag is zero, Condition 6 is met, and the controller 3 provides the notification to the driver.

Then, at the second detection, it is assumed that the traffic light 500 has not been detected. At the third detection, it is assumed that the traffic light 500 has been detected again. In this case, since Conditions 1 to 5 are met, and the number of outputs of the green light disregard flag is one, the controller 3 determines that Condition 6 is not met, and stops the re-notification.

As a result, when the traffic light 500 has not been detected at the intermediate detection (second detection) and has detected at the next detection (third detection), the notification is not treated as the first notification. Thus, it is possible to reduce the annoyance of the driver due to the notification.

When the forward vehicle exists while the own vehicle C is stopped at the traffic light 500, and when the traffic light 500 has changed from red to green in a state where the forward vehicle has not started, the controller 3 does not provide the notification. When the traffic light 500 has changed from red to green again, and then the forward vehicle has started, the controller 3 provides the notification. As a result, by providing the notification when the own vehicle C disregards the green light although the forward vehicle has started, it is possible to prompt the driver to start the own vehicle C.

For the first notification, for example, when the controller 3 detects that the own vehicle C has been parked on the street before the notification, the controller 3 may stop the notification. As a result, since the notification to prompt the driver to start the own vehicle C is not provided at parking on street, it is possible to further reduce the annoyance of the driver due to the notification.

Detection of parking on street may be performed by various sensors of the own vehicle and based on control states of the own vehicle. For example, when the controller 3 detects a state where a hazard lamp of the own vehicle is turned on, a state where a side mirror is folded, a state where the own vehicle is stopped on a roadside by lane detection, and the like, the controller 3 determines that the own vehicle is parked on the street and stops the first notification. In addition, when the controller 3 detects that the own vehicle is parked based on information of the vehicle speed sensor, the image captured by the camera 100, the positional information, and the like, the controller 3 does not provide the first notification.

Determination of parking on street may be made by obtaining vehicle shift information of the own vehicle. When a shift signal indicates “parking”, the controller 3 may determine that the own vehicle is parked on the street (stopped). Furthermore, when the own vehicle is in a parking monitor mode that records using the drive recorder 1 during parking of the own vehicle, the controller 3 may determine that the own vehicle is parked on the street (continues to stop).

For example, when the occupant, such as the driver, operates a button of the drive recorder 1, the mode may be shifted to the parking monitor mode. Alternatively, when an IG of the own vehicle is turned off, the mode may be automatically shifted to the parking monitor mode.

When the vehicle has not started and continues to stop (e.g., parking on street), the controller 3 provides the notification about violation of parking or stopping based on a positional relationship between the traffic light 500 and the own vehicle. Specifically, the controller 3 analyzes the image captured by the camera 100, and specifies a distance between the own vehicle and the traffic light 500. When the distance is less than a threshold value (e.g., less than 5 m), the controller 3 provides the notification about the violation of parking or stopping stating that the own vehicle is located in a no-stopping/parking area around the traffic light 500 (for example, display or voice that “This is a no-parking area. Please move immediately.”). As a result, the controller 3 prompts the driver to move the own vehicle from the no-stopping/parking area immediately.

In a period in which the controller 3 continues not to provide the re-notification, when a stop time of the own vehicle exceeds a predetermined time, the controller 3 may provide the re-notification. As a result, when the own vehicle is disregarding the green light for an extended period of time, the re-notification prompts the driver to start the own vehicle.

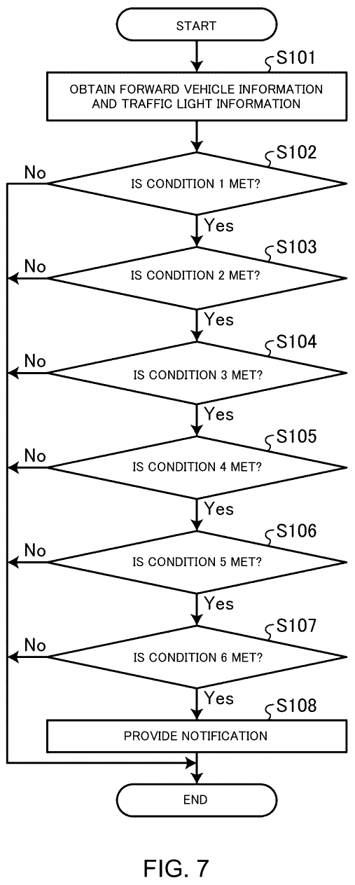

Next, a processing procedure of a notification process of the drive recorder 1 according to the embodiment will be described with reference to FIG. 7. FIG. 7 is a flowchart of the processing procedure of the notification process of the drive recorder 1 according to the embodiment. The process shown in FIG. 7 is repeatedly performed after the own vehicle is activated (IG on).

First, the controller 3 obtains forward vehicle information and traffic light information (positional information and color information) (a step S101).

Subsequently, the controller 3 determines whether or not Condition 1 is met (a step S102). Specifically, the controller 3 determines whether the own vehicle is moving or stopped in the process of Condition 1.

When Condition 1 is met (Yes in the step S102), that is, when the own vehicle is stopped, the controller 3 determines whether or not Condition 2 is met (a step S103). Specifically, the controller 3 determines whether or not the traffic light has changed from red to green in the step S103. On the other hand, when Condition 1 is not met (No in the step S102), that is, when the own vehicle is moving, the controller 3 ends the process. That is, the controller 3 stops the notification process without providing the notification.

In the step S103, when Condition 2 is met (Yes in the step S103), that is, when the traffic light has changed from red to green, the controller 3 determines whether or not Condition 3 is met (a step S104). Specifically, the controller 3 determines whether or not the threshold time TH or more has elapsed from the time at which the traffic light had changed from red to green. On the other hand, when Condition 2 is not met (No in the step S103), that is, when the traffic light has not changed from red to green, the controller 3 ends the process.

In the step S104, when Condition 3 is met (Yes in the step S104), that is, when the threshold time TH or more has elapsed from the time at which the traffic light had changed from red to green, the controller 3 determines whether or not Condition 4 is met (a step S105). Specifically, the controller 3 determines whether or not the forward vehicle exists within the threshold distance. On the other hand, when Condition 3 is not met (No in the step S104), that is, the threshold time TH or more has not elapsed from the time at which the traffic light had changed from red to green, the controller 3 ends the process.

In the step S105, when Condition 4 is met (Yes in the step S105), that is, when the forward vehicle does not exist within the threshold distance, the controller 3 determines whether or not Condition 5 is met (a step S106). Specifically, the controller 3 determines whether or not the number of green changes of the traffic light is one or less, and the number of red changes is zero. On the other hand, when Condition 4 is not met (No in the step S105), that is, when the forward vehicle exists within the threshold distance, the controller 3 ends the process.

In the step S106, when Condition 5 is met (Yes in the step S106), that is, when the number of green changes of the traffic light is one or less, and the number of red changes is zero, the controller 3 determines whether or not Condition 6 is met (a step S107). Specifically, the controller 3 determines whether or not the number of outputs of the green light disregard determination flag is zero. On the other hand, when Condition 5 is not met (No in the step S106), that is, when the number of green changes of the traffic light is two or more, or when the number of red changes is one or more, the controller 3 ends the process.

In the step S107, when Condition 6 is met (Yes in the step S107), that is, when the number of outputs of the green light disregard determination flag is zero, the controller 3 provides the notification to prompt the driver to start the own vehicle (a step S108), and ends the process.

On the other hand, when Condition 6 is not met (No in the step S107), that is, when the number of outputs of the green light disregard determination flag is one or more, the controller 3 ends the process.

As described above, the in-vehicle apparatus (drive recorder 1) according to the embodiment provides the notification to the driver of the vehicle when the vehicle has not started after the traffic light detected by the image recognition from the image captured by the camera during the stop of the vehicle had changed from red to green. The in-vehicle apparatus (drive recorder 1) according to the embodiment has the controller 3. The controller 3 does not provide the re-notification when the traffic light has changed from red to green in the state where the vehicle has not started and continues to stop even after providing the notification.

According to this embodiment, when the traffic light has changed from red to green in the state where the vehicle continues to stop even after the first notification, by stopping the re-notification, the notification is prevented from being repeated although the driver does not intend to start the vehicle. That is, according to this embodiment, it is possible to reduce the annoyance of the driver due to the notification.

It is possible for a person skilled in the art to easily come up with more effects and modifications. Thus, a broader modification of this invention is not limited to specific description and typical embodiments described and expressed above. Therefore, various modifications are possible without departing from the general spirit and scope of the invention defined by claims attached and equivalents thereof.

While the invention has been shown and described in detail, the foregoing description is in all aspects illustrative and not restrictive. It is therefore understood that numerous other modifications and variations can be devised without departing from the scope of the invention.

What is claimed is:

1. An in-vehicle apparatus comprising a controller, the controller configured to
provide a first notification to prompt a driver to start a vehicle in response to determining that the vehicle continues to stop until a first predetermined time elapses after detecting, by image recognition of an image captured by a camera, that a traffic light has changed from red to green, and
perform a process of not providing a second notification to prompt the driver to start the vehicle in response to detecting that the traffic light has changed from red to green again while the vehicle continues to stop after providing the first notification.

2. The in-vehicle apparatus according to claim 1, wherein
the controller resets the process of not providing the notification to prompt the driver to start the vehicle in response to detecting that the vehicle has started.

3. The in-vehicle apparatus according to claim 1, wherein
in response to a stop time of the vehicle exceeding a second predetermined time, the controller provides the notification to prompt the driver to start the vehicle.

4. The in-vehicle apparatus according to claim 1, wherein
in response to detecting a shift signal of the vehicle indicates parking, the controller determines that the vehicle is stopped.

5. The in-vehicle apparatus according to claim 1, wherein
in response to detecting the vehicle is in a parking monitor mode in which recording is performed during parking, the controller determines that the vehicle continues to stop.

6. The in-vehicle apparatus according to claim 1, wherein
in response to detecting the vehicle has not started and continues to stop, the controller provides a notification about violation of parking or stopping based on a positional relationship between the traffic light and the vehicle.

7. The in-vehicle apparatus according to claim 1, wherein
in response to detecting the traffic light has changed from red to green in a state where a forward vehicle has not started, the controller does not provide the notification to prompt the driver to start the vehicle, and in response to the traffic light has changed from red to green again and then the forward vehicle has started, the controller provides the notification to prompt the driver to start the vehicle.

8. The in-vehicle apparatus according to claim 1, wherein
in response to detecting the vehicle has not started and continues to stop even after the controller provides the notification to prompt the driver to start the vehicle by display and voice, the controller provides either the notification by display or the notification by voice.

9. The in-vehicle apparatus according to claim 1, wherein
the controller counts a number of changes from red to green in the traffic light while the vehicle continues to stop, and
in response to an accumulated value of the number of changes being a threshold value or more, the controller performs the process of not providing the second notification.

10. The in-vehicle apparatus according to claim 9, wherein
in response to having detected a plurality of the traffic lights by image recognition, the controller counts the number of changes for each of the plurality of the traffic lights, and
in response to the accumulated value of the number of changes being the threshold value or more, the controller performs the process of not providing the second notification.

11. The in-vehicle apparatus according to claim 10, wherein
in response to detecting the vehicle has started and then stopped, the controller resets the accumulated value of the number of changes.

12. The in-vehicle apparatus according to claim 1, wherein
in response to detecting the traffic light has changed from green to red while the vehicle continues to stop, the controller performs the process of not providing the second notification.

13. The in-vehicle apparatus according to claim 1, wherein
before providing the notification to prompt the driver to start the vehicle, in response to detecting that the vehicle is parked based on information of a vehicle speed sensor mounted in the vehicle, the image captured by a camera, or positional information, the controller does not provide the notification to prompt the driver to start the vehicle.

14. An in-vehicle apparatus comprising a controller, the controller configured to
provide a notification to a driver of a vehicle in response to determining the vehicle has not started after a traffic light detected by image recognition from an image captured by a camera during a stop of the vehicle had changed from red to green, and
perform a process not to provide the notification until the vehicle starts after providing the notification.

15. A non-transitory computer readable recording medium storing a program that causes a computer of an in-vehicle apparatus to execute a process that provides a notification to a driver of a vehicle in response to determining the vehicle has not started after a traffic light detected by image recognition from an image captured by a camera during a stop of the vehicle had changed from red to green, the process comprising:
not providing the notification until the vehicle starts after providing the notification.
